(19) United States
(12) Patent Application Publication
(10) Pub. No.: US 2001/0049962 A1
(43) Pub. Date: Dec. 13, 2001

(54) Electronic scanning ultrasonic object-detection apparatus and method thereof

(75) Inventors: Yo Yanagida, Shizuoka-ken (JP); Kazuyuki Osada, Shizuoka-ken (JP); Terumitsu Sugimoto, Shizuoka-ken (JP)

Correspondence Address: Finnegan, Henderson, Farabow,, Garrett & Dunner, L.L.P., 1300 I Street, N.W., Washington, DC, 20005-3315, US

(73) Assignee: Yazaki Corporation

(21) Appl. No.: 09/841,099

(22) Filed: Apr. 25, 2001

(30) Foreign Application Priority Data
Apr. 26, 2000 (JP) P 2000-125828

(51) Int. Cl. G01N 29/00

(52) U.S. Cl. 73/628; 73/606

(57) ABSTRACT

An electronic scanning ultrasonic object-detection apparatus 1 of the present invention comprises; phase control signal generation means 2 for generating a plurality of phase control signals having different transmission frequencies; ultrasonic wave transmission means 3 for transmitting ultrasonic waves of a transmission frequency different from each other by a plurality of arrays, based on the plurality of phase control signals; ultrasonic wave receiving means 4 for receiving reflected waves from an object of the ultrasonic waves with a plurality of receiving elements, judging a signal of the reflected waves received by all the receiving elements as a mail image to thereby output a mail image signal, and judging signals of other reflected waves as side images to thereby output a side image signal; and object-detection means 5 for detecting a position of an object based on the mail image signal output by the ultrasonic wave receiving means 4, and detecting existence of a side image based on the side image signal.

### BACKGROUND OF THE INVENTION

The present invention relates to an electronic scanning ultrasonic object-detection apparatus for detecting an object existing in the space by ultrasonic waves, and more specifically, relates to an electronic scanning ultrasonic object-detection apparatus that can prevent misdetection due to a side beam.

Conventionally, there exist an ultrasonic array sensor as shown in FIG. I (Japanese Patent Application Laid-Open No. 10-224880), and a phased array oscillator driving method as shown in FIG. 2 (Japanese Patent Application Laid-Open No. 59-34176).

First, the ultrasonic array sensor 101 shown in FIG. 1 comprises tubular waveguides 103 for guiding ultrasonic waves, and ultrasonic oscillators 105 equipped at one end portion 107 of the wavesguides 103a, 103b and 103c, for sending ultrasonic waves out towards the other end portion 109 of the waveguides 103a, 103b and 103c, wherein the waveguides 103a, 103b and 103c equipped with the ultrasonic oscillator 105 are arranged in plural numbers. Then, the shape of the other end portion 109 of each waveguide 103a, 103b and 103c is made substantially rectangular, respective other end portions 109 of each waveguide 103a, 103b and 103c are arranged in a row, wherein one end portions 107 of adjacent waveguides, in each waveguide 103a, 103b and 103c, are extended in directions different from each other,

Moreover, the alignment interval at the other end portion 109 of waveguides 103a, 103b and 1O3c is set to be not larger than the half-wave length of ultrasonic waves generated by the ultrasonic oscillator 105.

As described above, the ultrasonic array sensor 101 shown in FIG. 1 is constructed such that the alignment interval d at the other end portion 109 of waveguides from which ultrasonic waves are transmitted is set to be shorter than the half-wave length of ultrasonic waves, to thereby prevent a so-called sub-pole (side beam) from occurring.

Meanwhile, with the phased array oscillator driving method as shown in FIG. 2, ultrasonic sensing elements TD₁-TDₙ (in this case, n=12) are arranged on a line at a pitch d, as shown in FIG. 2A, and at the time of wave receiving, the wave is received with alternate six elements (TD₁, TD₃, TD₅, TD₇, TD₉, TD₁₁, and at a pitch of 2d) among twelve elements, as shown in FIG. 2C. In this case, a grating side lobe appears in the direction of θₓ and −θₓ (not shown) with respect to the main beam, and a phase difference of just one wavelength occurs between adjacent elements in that direction. The sensitivity directivity at this time is as shown in FIG. 3B.

On the other hand, at the time of wave transmission, as shown in FIG. 2B, sound wave is emitted by central six elements (TD₄-TD₆, at a pitch of d). In the direction of θₓ and −θ₃₁ (not shown), the phase difference of the half-wave length occurs between adjacent elements, and hence these elements counteract each other to have the minimum strengths and the directivity at the time of wave transmission is as shown in FIG. 3A.

Here, if the time of wave transmission and the time of wave receiving are put together, the directivity synthesizing each directivity of transmission and reception is obtained, and hence it becomes the directivity as shown in FIG. 3C, and it is seen that the directivity becomes such that it suppresses the grating side lobe.

However, with the ultrasonic array sensor 101 described above, the sound source interval constituting the array Is made not larger than half-wave length, to thereby substantially suppress occurrence of the side beam. However, since the diameter of the ultrasonic oscillator 105 is really larger than the half-wave length, the sound source interval is made to be not larger than the half-wave length by extending the waveguide from the element. Therefore, the sensor section increases, which is not practical.

Moreover, with the phased array oscillator driving method shown in FIG. 2, substantial sensitivity is limited only in the main beam direction, by making the directivity of the transmission array and the directivity of the receiving array different. In this case, however, a complicated circuit structure is required in both the phase control circuit of a signal input to the transmission array and the detection signal processing circuit in the receiving array,

### SUMMARY OF THE INVENTION

The present invention has been completed under the above situation, and it is an object of the present invention to provide an electronic scanning ultrasonic object-detection apparatus and a method thereof, which can prevent misdetection caused by a side beam, and decrease the size of the sensor section without making the circuit structure of a receiving section complicated.

As the apparatus for achieving the above object, an electronic scanning ultrasonic object-detection apparatus, which is the invention according to claim 1 is an electronic scanning ultrasonic object-detection apparatus for detecting a position of an object by transmitting ultrasonic waves, comprising: phase control signal generation means for generating a plurality of phase control signals having different transmission frequencies; ultrasonic wave transmission means for transmitting ultrasonic waves of a transmission frequency different from each other by a plurality of arrays, based on the plurality of phase control signals generated by the phase control signal generation means; ultrasonic wave receiving means for receiving reflected waves from an object of the ultrasonic waves transmitted by the ultrasonic wave transmission means with a plurality of receiving elements, judging a signal of the reflected waves received by all the receiving elements as a mail image to thereby output a mail image signal, and judging signals of other reflected waves as side images to thereby output a side image signal; and object-detection means for detecting a position of an object based on the mail image signal output by the ultrasonic wave receiving means, and detecting existence of a side image based on the side image signal.

According to claim 1 of the invention, a mail image and a side image can be separately recognized, thereby enabling prevention of misdetection of an object.

The invention according to claim 2 is an electronic scanning ultrasonic object-detection apparatus according to claim 1, wherein the ultrasonic wave receiving means has logical operation means for transforming the reflected waves to pulse signals, and thereafter, collectively calculating the pulse signals.

Further, the invention according to claim 3 is an electronic scanning ultrasonic object-detection apparatus according to claim 1, wherein the ultrasonic wave receiving means has logical operation means for transforming the reflected waves to pulse signals, and thereafter, detecting signals of which time required from transmission to reception is the same as a mail image pulse, among the pulse signals.

In addition, the invention according to claim 4 is an electronic scanning ultrasonic object-detection apparatus, wherein the ultrasonic wave receiving means has logical operation means for transforming the reflected waves to pulse signals, and thereafter, detecting signals of which time required from transmission to reception is different as a side image pulse, among the pulse signals.

According to claims 2, 3 and 4 of the invention, after the reflected waves are transformed to pulse signals, a plurality of received signals can be collectively processed by a simple logic circuit, that is a simple combination of a logical multiplication and a logical addition, thereby enabling miniaturization of the construction of the receiving circuit, and also enabling judgment of existence of a “side image”.

As a method for achieving the above object, an electronic scanning ultrasonic object-detection method, which is the invention according to claim 5, is an electronic scanning ultrasonic object-detection method for detecting a position of an object by transmitting ultrasonic waves, comprising; a phase control signal generation step for generating a plurality of phase control signals having different transmission frequencies; an ultrasonic wave transmission step for transmitting ultrasonic waves of a transmission frequency different from each other by a plurality of arrays, based on the plurality of phase control signals generated by the phase control signal generation step; an ultrasonic wave receiving step for receiving a reflected wave from an object of the ultrasonic wave transmitted in the ultrasonic wave transmission step, with a plurality of receiving elements, judging a signal of the reflected wave received by all the receiving elements as a mail image to thereby output a mail image signal, and judging signals of other reflected waves as side images to thereby output a side image signal: and an object-detection step for detecting a position of an object based on the mail image signal output in the ultrasonic wave transmission step, and detecting existence of a side image based on the side image signal.

According to claim 5 of the invention, a mail image and a side image can be separately recognized, thereby enabling prevention of misdetection of an object.

The invention according to claim 6 is an electronic scanning ultrasonic object-detection method according to claim 5, wherein the ultrasonic wave receiving step has a logical operation step for transforming the reflected waves to pulse signals, and thereafter, collectively calculating the pulse signals.

Further, the invention according to claim 7 is an electronic scanning ultrasonic object-detection method according to claim 5, wherein the ultrasonic wave receiving step has a logical operation step for transforming the reflected waves to pulse signals, and thereafter, detecting signals of which time required from transmission to reception is the same as a mail image pulse, among the pulse signals.

In addition, the invention according to claim 8 is an electronic scanning ultrasonic object-detection method according to claim 5, wherein the ultrasonic wave receiving step has a logical operation step for transforming the reflected waves to pulse signals, and thereafter, detecting signals of which time required from transmission to reception is different as a side image pulse, among the pulse signals.

According to claims 6, 7 and 8 of the invention, after the reflected waves are transformed to pulse signals, a plurality of receiving signals can be collectively calculated and processed by a simple logic circuit, that is a simple combination of a logical multiplication and a logical addition, thereby enabling miniaturization of the construction of the receiving circuit, and also enabling judgment of existence of a “side image”.

### BRIEF DESCRIPTION OF THE DRAWINGS

FIG. 1 is a diagram showing the construction of a conventional ultrasonic array sensor.

FIG. 2 is a diagram for explaining the principle of a conventional phased array oscillator driving method.

FIG. 3 is a diagram showing the sensitivity directivity in the conventional phased array oscillator driving method.

FIG. 4 is a block diagram showing the construction of one embodiment of an electronic scanning ultrasonic object-detection apparatus according to the present invention.

FIG. 5 is a block diagram showing the construction of one embodiment of ultrasonic wave transmission means 3 in the electronic scanning ultrasonic object-detection apparatus 1 shown in FIG. 4.

FIG. 6 is a circuit diagram showing a circuit structure of ultrasonic wave transmission means 3 in the electronic scanning ultrasonic object-detection apparatus 1 shown in FIG. 4.

FIG. 7 is a circuit diagram showing a circuit structure of ultrasonic wave receiving means 4 in the electronic scanning ultrasonic object-detection apparatus 1 shown in FIG. 4.

FIG. 8 is a diagram showing a beam profile model of ultrasonic waves transmitted by the array.

FIG. 9 is a diagram showing one example of ultrasonic wave transmission means 3 in the electronic scanning ultrasonic object-detection apparatus 1 shown in FIG. 4.

FIG. 10 is a diagram showing one example of ultrasonic wave transmission means 3 in the electronic scanning ultrasonic object-detection apparatus 1 shown in FIG. 4.

FIG. 11 is a diagram showing one example of the electronic scanning ultrasonic object-detection apparatus 1 shown in FIG. 4.

FIG. 12 is a flowchart for explaining an object-detection processing by means of the electronic scanning ultrasonic object-detection apparatus 1 shown in FIG. 4.

FIG. 13 is a diagram showing one example of a phase control signal input to the ultrasonic wave transmission means 3 shown in FIG. 4.

PIG. 14 is a diagram for explaining the principle of the main beam directivity control by means of the ultrasonic wave transmission means 3 shown in FIG. 4.

FIG. 15 is a diagram for explaining the principle of generating a side beam by the ultrasonic wave transmission means 3 shown in FIG. 4.

FIG. 16 is a diagram showing one example of the generation directions of the main beam and the side beam.

FIG. 17 is a diagram showing a receiving signal by means of the reflected wave from an object, received by the ultrasonic wave receiving means 4 shown in FIG. 4.

FIG. 18 Is a diagram showing one example of a receiving signal by means of the reflected wave from an object, received by the ultrasonic wave receiving means 4 shown in FIG. 4.

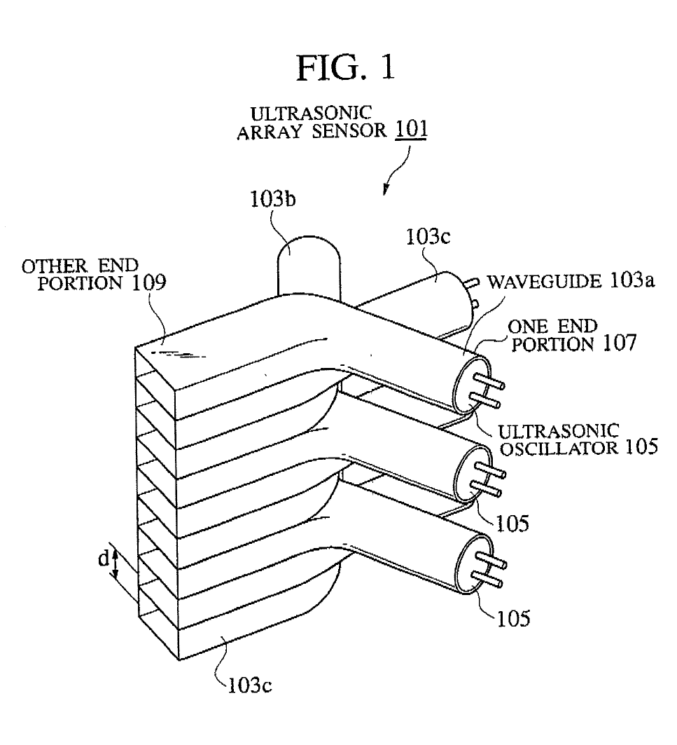

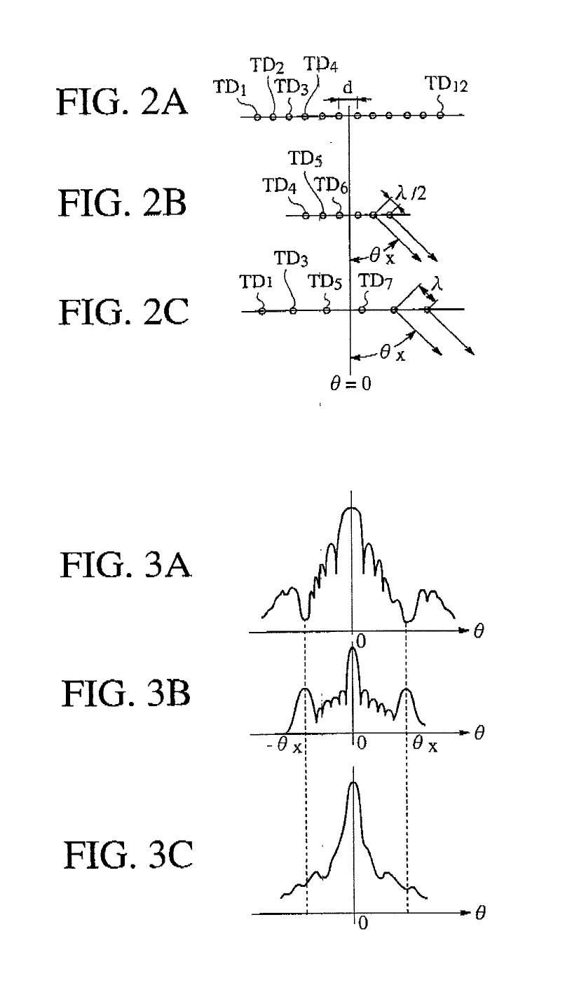

### DESCRIPTION OF THE PREFERRED EMBODIMENT

At first, the construction of an electronic scanning ultrasonic object-detection apparatus in this embodiment will be described, based on FIG, 4.

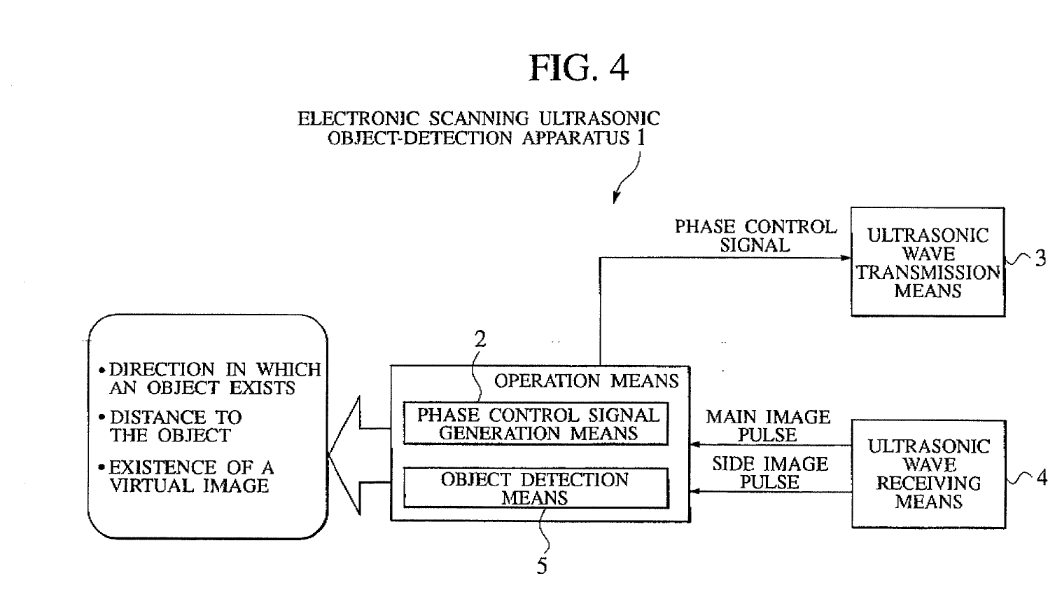

As shown in FIG. 4, the electronic scanning ultrasonic object-detection apparatus 1 in this embodiment comprises: phase control signal generation means 2 for generating a plurality of phase control signals having different transmission frequencies; ultrasonic wave transmission means 3 for transmitting ultrasonic waves of a transmission frequency different from each other by a plurality of arrays, based on the plurality of phase control signals generated by the phase control signal generation means 2; ultrasonic wave receiving means 4 for receiving a reflected wave from an object of the ultrasonic wave transmitted by the ultrasonic wave transmission means 3, with a plurality of receiving elements, judging a signal of the reflected wave received by all the receiving elements as a mail image to thereby output a mail image signal, and judging signals of other reflected waves as side images to thereby output a side image signal; and object-detection means 5 for detecting a position of an object based on the mail image signal output by the ultrasonic wave transmission means 4, and detecting existence of a side image based on the side image signal.

The electronic scanning ultrasonic object-detection apparatus 1 constructed as described above transmits ultrasonic waves having different transmission frequencies from the ultrasonic wave transmission means 3, based on the phase control signals generated by the phase control signal generation means 2, and receives reflected waves of the ultrasonic waves from an object by the ultrasonic wave receiving means 4 to thereby separate a mail image pulse and a side image pulse. Then, based on the mail image pulse and the side image pulse, information such as “direction in which an object exists”, “distance to the object”, “existence of a side image” and the like are calculated and output by the object-detection means 5.

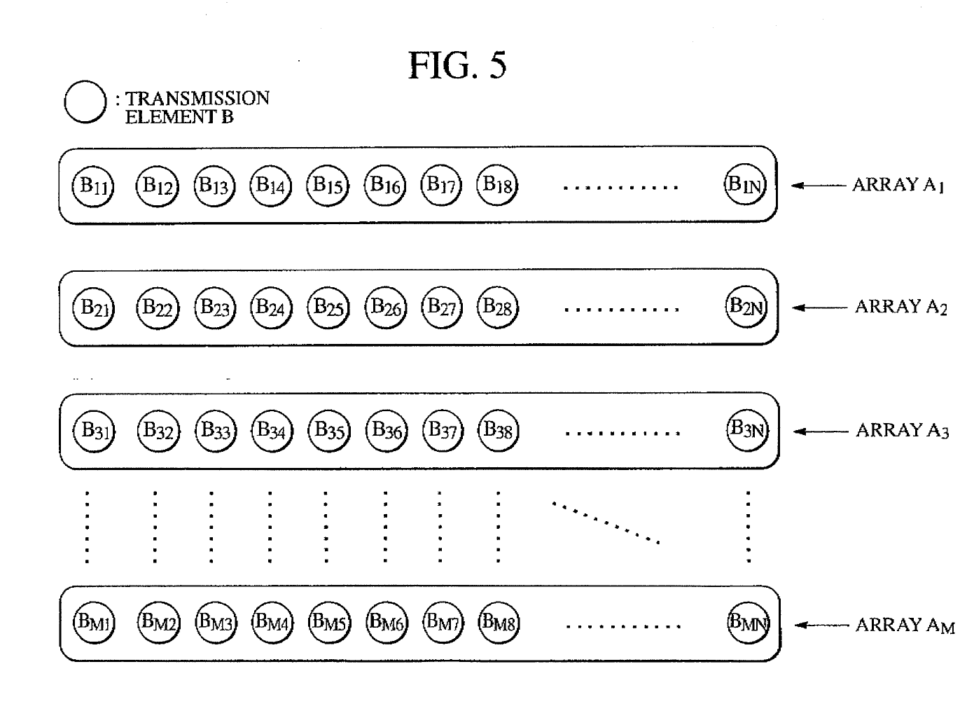

Here, the ultrasonic wave transmission means 3 is constructed, as shown in FIG. 5, by arranging a plurality of arrays in which a plurality of transmission elements B are arranged linearly at equal intervals.

In FIG. 5, there is shown an ultrasonic wave transmission means 3 comprising an array A₁ constituted of N transmission elements B₁₁, B₁₂, . . . , B_{1N}, an array A₂ constituted of N transmission elements B₂₃, B₂₂, . . . , B_{2N}, and an array A_{M} constituted of N transmission elements B_{M1}, B_{M2}, . . . , B_{MN}. Here, the alignment interval d of the transmission elements in all arrays A₁ to A_{M} are the same.

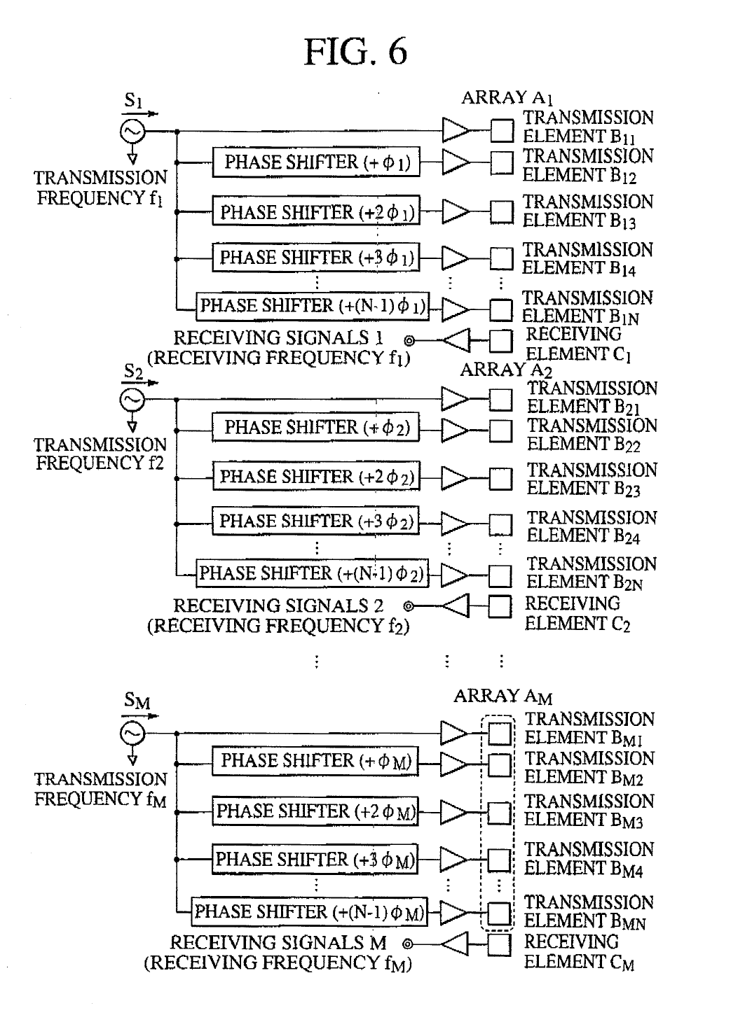

Further, the circuit structure of the ultrasonic wave transmission means 3 will now be described, based on FIG. 6.

As shown in FIG. 6, M phase control signals S₁, S₂, . . . , S_{M} generated by the phase control signal generation means 2 are input to the ultrasonic wave transmission means 3. Of these phase control signals, the phase control signal S₁ input to the array A₁ is input to each transmission element B₁₁, B₁₂. . . , B_{1N}, with a specified phase difference φ₁ provided by a phase shifter 31. This phase difference φ₁ is determined by the transmission frequency and the main beam direction.

Then, each transmission element B₁₁, B₁₂. . . , B_{1N} transmits ultrasonic waves, respectively, based on the phase control signals S₁₁, S₁₂, . . . , S_{1N} provided with the phase difference. Therefore, each transmission element B₁₁, B₁₂, . . . , B_{1N} is to transmit ultrasonic waves having a phase difference of φ₁ between adjacent transmission elements, respectively.

Similarly, in the array A₂, . . . , A_{M}, ultrasonic waves having a phase difference of φ₂, . . . , φ_{M} are transmitted, respectively.

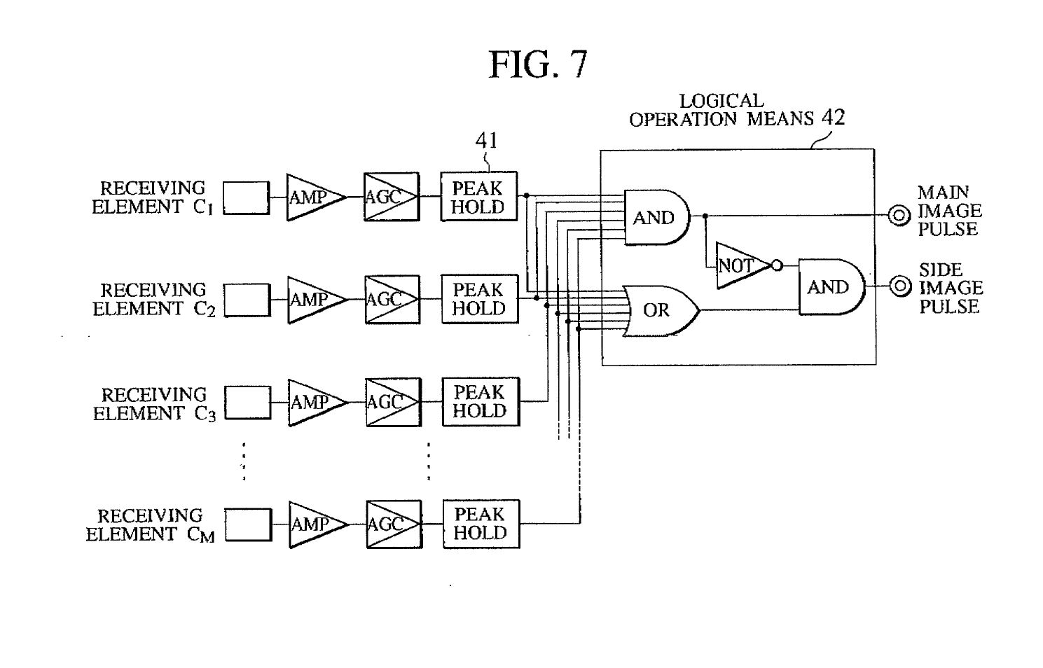

Moreover, the ultrasonic wave receiving means 4 is constituted of a plurality of receiving elements C₁, C₂, . . . , C_{M}, and the reflected waves from the object received by these receiving elements are identified as a mail image or a side image with a circuit shown in FIG. 7.

As shown in FIG. 7, M receiving elements C₁, C₂, . . . , C_{M} for receiving reflected waves having a frequency f₁ to f_{M}, respectively, receives the reflected waves from the object of ultrasonic waves transmitted at the same time from the transmission elements B₁₁, B₁₂, . . . , B_{1N}, B₂₁, . . . , B_{2N}, B^{M1}, . . . , B_{MN} having a transmission frequency of f₁ to f_{M}, respectively at the same time.

Then, the received reflected waves are amplified by an amplifier AMP all at once, and subjected to pulse transform by an automatic gain control device AGC and a peak hold circuit 41.

Next, an logical operation means 42 acquires a logical multiplication of M pulse signals generated in this manner, to thereby detect signals in which the time from transmission to reception is the same, that is, a mail image pulse.

Similarly, the logical operation means 42 acquires a logical addition of M pulse signals, to thereby detect signals in which the time from transmission to reception is different, that is, a side image pulse.

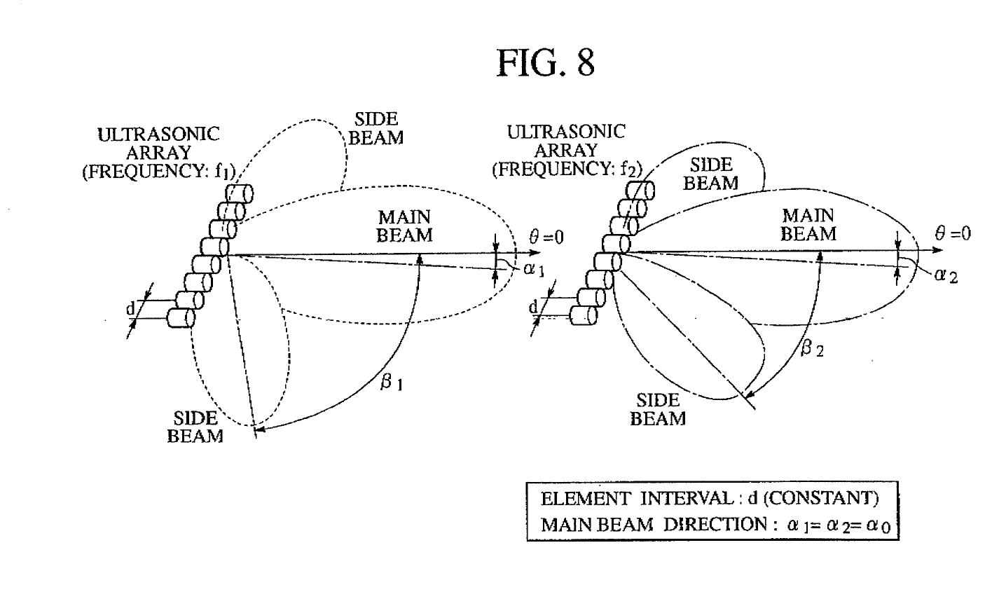

Here, as shown in FIG. 8, a case where the apparatus is constituted of two arrays, that is, an array A₁ having a transmission frequency of F₁ and an, array A₂ having a transmission frequency of F₂, will be described as an example.

FIG. 8 shows beam profile models formed by the arrays A₁ and A₂, respectively, and the alignment interval of the transmission elements is d, and the main beam direction is α₀, in the both arrays A₁ and A₂.

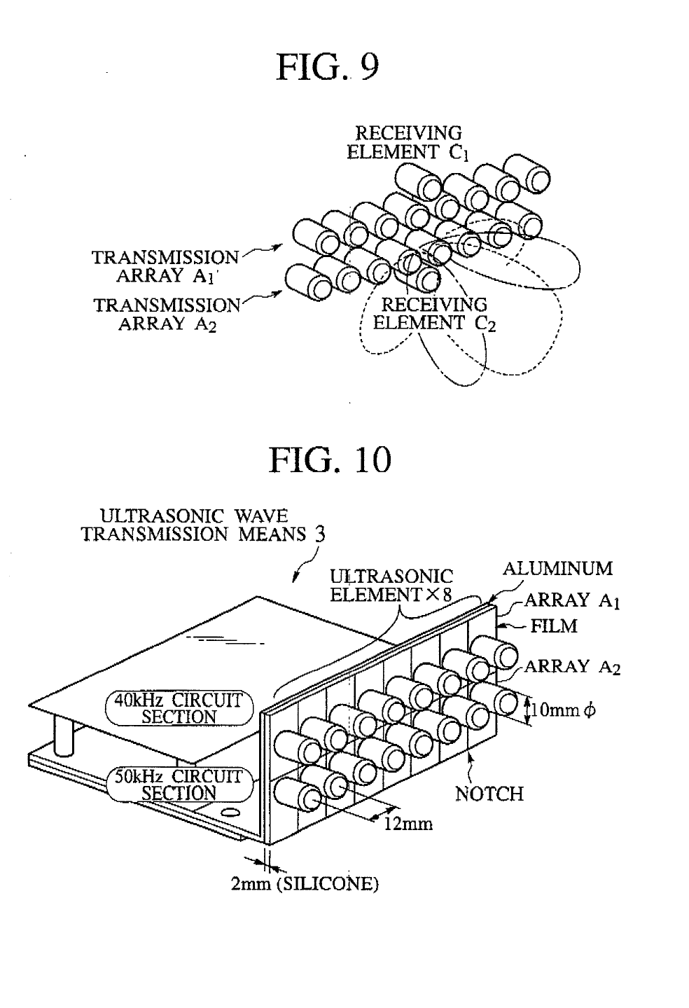

These arrays A₁ and A₂ are arranged as shown in FIG. 9, to thereby constitute the ultrasonic wave transmission means 3.

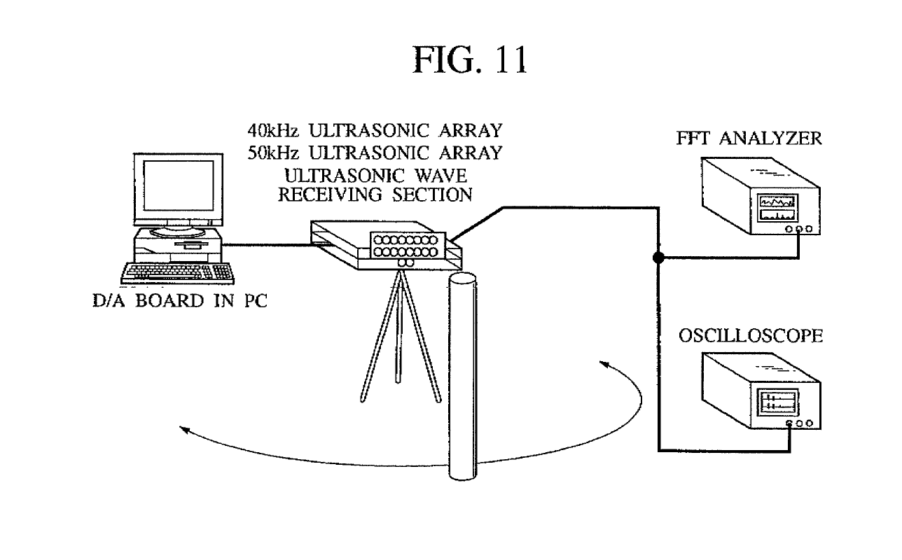

Here, one example of the ultrasonic wave transmission means 3 constituted of the two arrays is shown in FIG. 10. In FIG, 10, eight transmission elements having a transmission frequency of 40 kHz are installed in the array A₁ formed on the upper stage, and eight transmission elements having a transmission frequency of 50 kHz are installed in the array A₂ formed on the lower stage.

In these arrays A₁ and A₂, the diameter of the transmission element is 10 mm, and the alignment interval between the transmission elements is set to be 12 mm.

Moreover, an example of an electronic scanning ultrasonic object-detection apparatus utilizing the ultrasonic wave transmission means shown in FIG. 10 is shown in FIG. 11. In FIG, 11, a personal computer provided with a D/A board is connected to the ultrasonic wave transmission means 3 shown in FIG. 10 to thereby output a phase control signal, and the receiving signal is observed by an FFT analyzer and an oscilloscope.

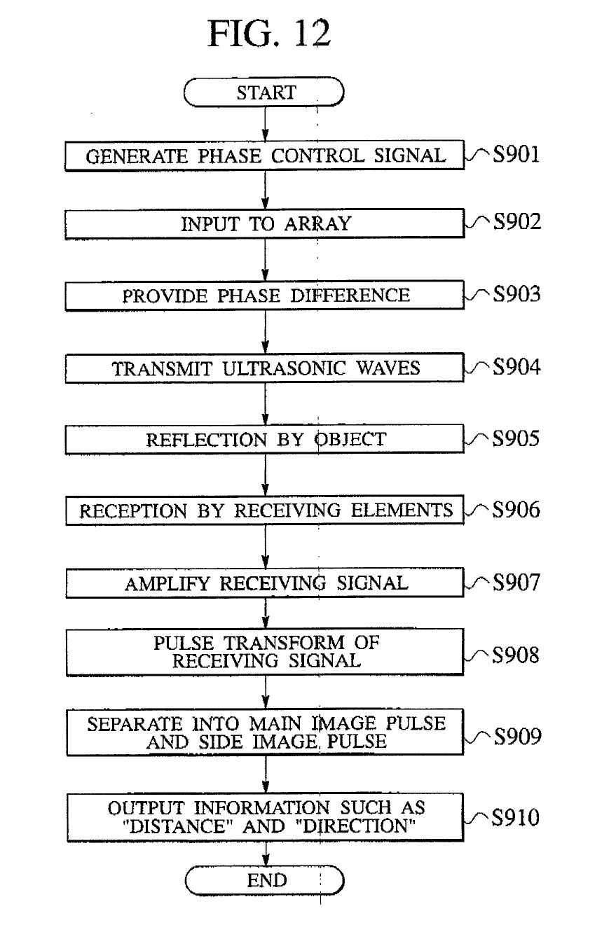

Next, object-detection processing by means of the electronic scanning ultrasonic object-detection apparatus 1 in this embodiment will be described, based on the flowchart in FIG. 12.

At first, one phase control signal is generated with respect to one array, by the phase control signal generation means 2 (S901). At this time, a phase control signal S₁ of 40 kHz is generated with respect to the array A₁, and a phase control signal S₂ of 50 kHz is generated with respect to the array A₂.

These phase control signals S₁, S₂ are transmitted to arrays A₁ and A₂, respectively, and input at the same time to each array (S902).

Then, in each array A₁, A₂ that has received the phase control signal, a specified phase difference is provided between the adjacent transmission elements by the phase shifter 31 shown in FIG. 6 (S903). This phase difference is determined by the transmission frequency and the main beam direction.

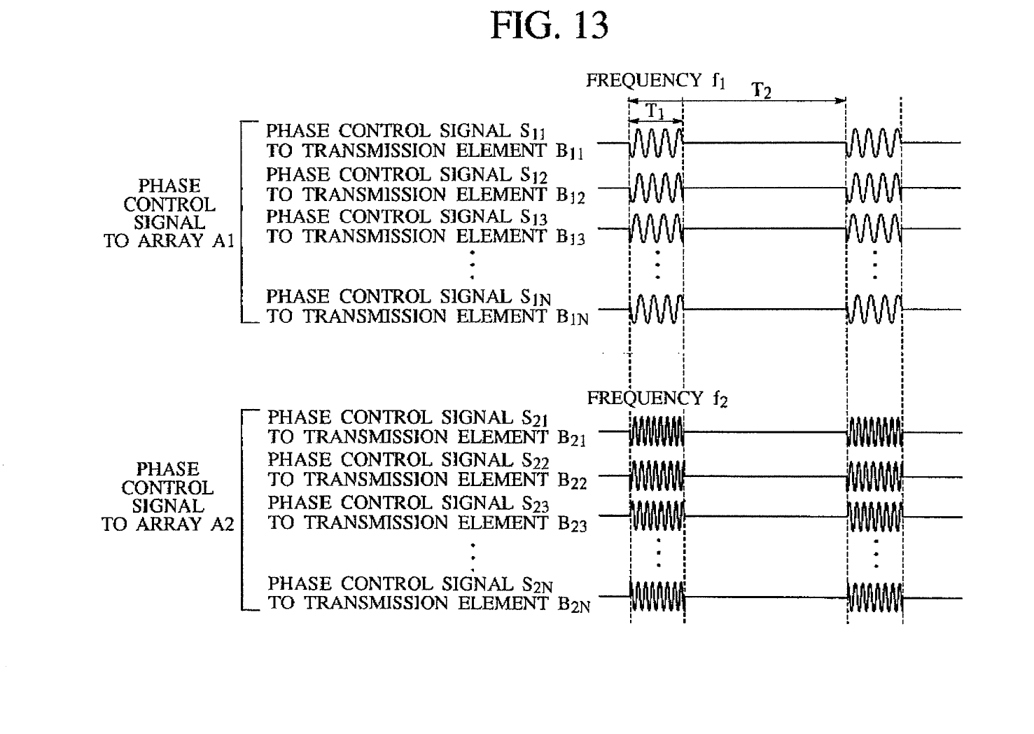

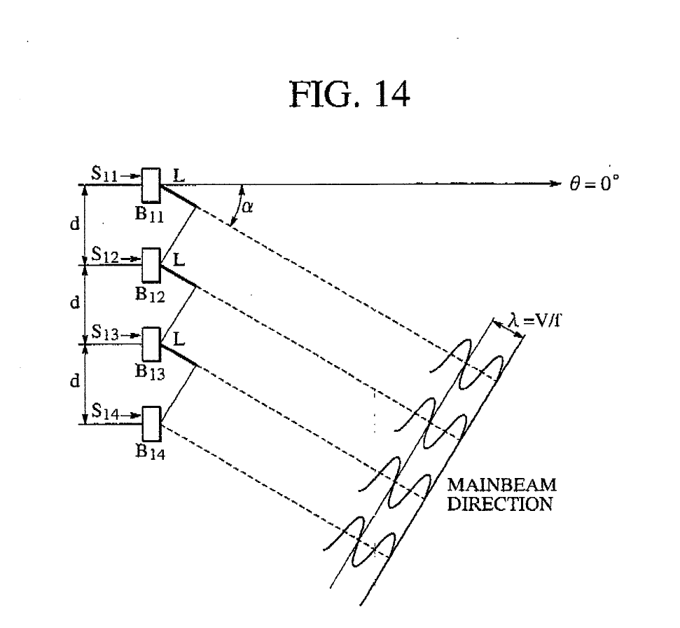

Here, one example of a phase control signal provided with a phase difference is shown in FIG. 13.

As shown in FIG. 13, in the array A₁, phase control signals S₁₁, S₁₂, S_{1N} having a transmission frequency of 40 kHz and provided with a specified phase difference are input, only for time T₁, of the sampling period T₂, with respect to N transmission elements B₁₁, B₁₂, B_{1N}. Such a phase control signal is input to N transmission elements B₁₁, B₁₂, B_{1N}, respectively, continuously and repeatedly.

In the same manner, phase control signals S₂₁, S₂₂, . . . , S_{2N} having a transmission frequency of 50 kHz are input to the array A₂.

Ultrasonic waves provided with a specified phase difference between ultrasonic waves transmitted from the adjacent transmission element are respectively transmitted from the transmission element B into which such a phase control signal has been input (S904).

Here, the principle of the directivity control of ultrasonic beams transmitted by the above-described ultrasonic wave transmission means 3 will be described based on FIG. 14. In this embodiment, the electronic scanning method stands for a method utilizing an interference phenomenon of wave motion, that is, a method for “generating a strong beam in the intended direction by adequately controlling phases of waves generated from a plurality of wave sources”.

Here, if it is assumed that phase control signals S₁₁, S₁₂, . . . , S₁₄ provided with a phase difference by the phase shifter 31 shown in FIG. 6 are input to the transmission elements B₁₁, B₁₂, . . . , B₁₄, in the array A₁, then, if the phase of each phase control signal S₁₁, S₁₂, . . . , S₁₄ are all the same, a strong ultrasonic beam is generated In the direction of θ=0°. This “strong ultrasonic beam” is referred to as a “main beam” hereinafter.

Here, considering a case where a main beam is generated in the direction of θ=α in FIG. 14, a path difference L of the transmission elements B₁₁ to B₁₄ in FIG. 14 becomes:

L =d.sinα (1).

A phase difference ψ[deg] required between respective phase control signals is determined from the time when the ultrasonic waves advance the distance L.

If the sonic velocity is denoted by V, and the transmission frequency is denoted by f, since the distance (wavelength λ) advanced while the wave of a frequency f shifts for one cycle is V/f, the following expressions are obtained:

φ/360=d.sinα/(V/f) . . . (2),

∴φ=(360.f.d.sinα)/V[deg] (3).

If φ obtained in the expression (3) is respectively provided as a phase difference between, the phase control signals S₁₁-S₁₂, S₁₂-S₁₃, and S₁₃-S₁₄, then the main beam can be generated in the direction of α by means of the array A₁.

However, since the main beam uses the “interference phenomenon of wave motion”, every time it is shifted from the main beam by an integral wavelength, a strong beam is formed separately from the main beam. This “strong ultrasonic beam shifted from the main beam by an integral wavelength” is referred to as a “side beam”.

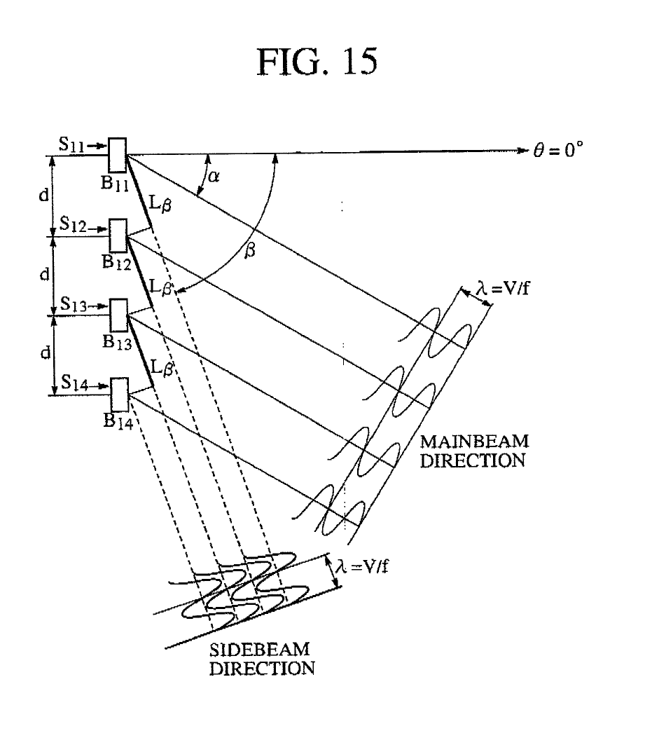

Here, the principle for generating the side beam will be described with reference to FIG. 15.

If it is assumed that the direction of the generated side beam is β, the path difference L_{β} in FIG. 15 becomes:

L_{β}=d.sinβ . . . (4).

As a result, a side beam is to be formed in the direction of β where the following expression is concluded:

|d.sinβ-d.sinα=n.λ (n=1, 2, 3, 4 . . .) (5).

From the expression (5), the direction β where the side beam appears becomes as follows;

β=sin⁻{sinα±n.(λ/d)} (n =1, 2, 3, 4 . . . ) (6).

The constrained conditions of α, β, λ, and d are:

−90°≦α≦+90°,

−90°≦α≦+90°,

λ>0, and

d>0 (7),

and hence, when the expression (6) is concluded under these conditions, a side beam is formed in the direction of β.

When the condition in which β exists is determined from the expressions (6) and (7), it becomes d≧λ/2. Inversely speaking, if

0<d<λ/2 (8)

then, a side beam is not formed in the space. Originally, the distance between wave sources (alignment interval between elements) d should be set so as to satisfy the expression (8).

However, practically, since currently available ultrasonic elements have a frequency: f=40 kHz-60 kHz (wavelength λ=8.5 mm-5.7 mm), and a diameter of the element of minimum of 10mm, it is quite difficult to make the distance between wave sources d narrower than λ/2.

Therefore, when considering the generation directions of the main beam and the side beam, in order to separate the “mail image” and the “side image”, using the currently available ultrasonic elements, from the expression (3), the main beam generation direction α is:

α=sin⁻¹{(V.φ)/(360.f.d)} (9).

On the other hand, from the expression (6), the side beam generation direction β is:

β=sin⁻¹{sinα±n.(λ/d)}

∴β=sin⁻¹{sinα±n.V/(f.d)}(n=1, 2, 3, 4, . . . ) . . . (10).

Here, if d is made constant, and f is changed, both α and β change.

However, β changes due to a change of f, but α can be made constant, by changing the phase difference φ, with a change of f.

This means that if a transmission frequency f to the transmission element is changed for each array, and the phase difference φ between transmission elements is changed together with the frequency change, only the generation direction β of the side beam can be changed, while keeping the main beam direction α constant.

As a result, if ultrasonic waves having a transmission frequency different from each other are transmitted from M arrays at the same time, even if the generation direction of the main beam are all α₀, the generation direction of the side beam transmitted from respective arrays are different.

That is to say,

α₁=α₂=α₃=. . . =α_{M}=α_{O},

β₁≠βⱼ, i≠j, i, j=1, 2, . . . , M.

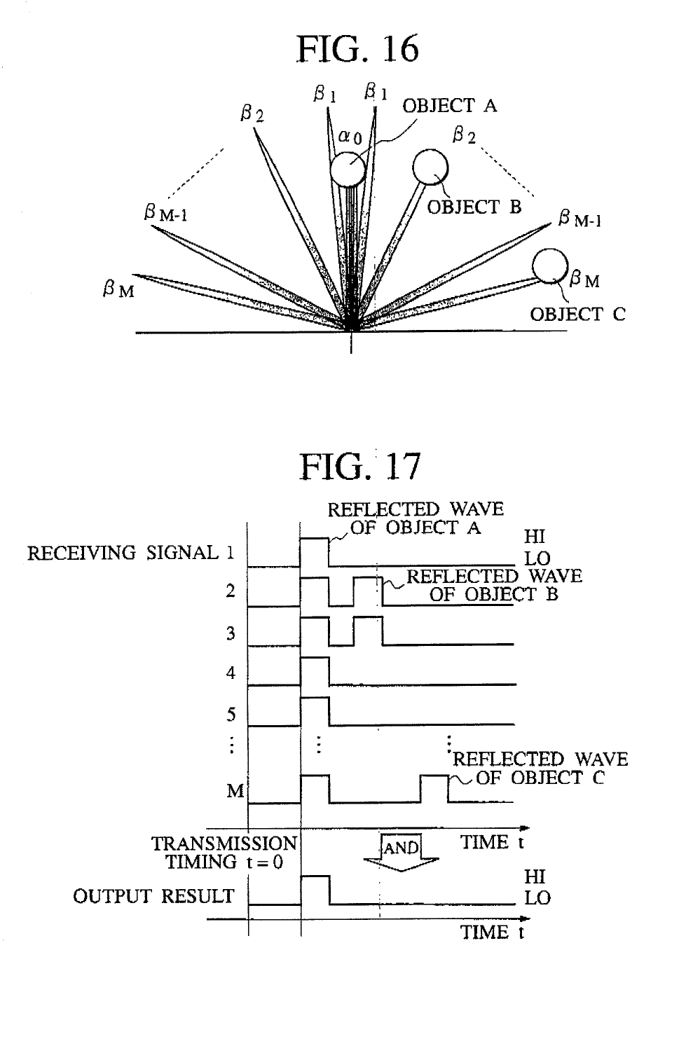

As a result, the main beam and the side beam transmitted from M arrays are generated in the direction as shown in FIG. 16.

Here, in the case where the main beam is generated in the direction of α₀, as shown in FIG. 16, the side beam is generated in the direction of β¹, β₂, β₃, . . . , β_{M}, and objects A, B and C exist, when reflected waves are received by the receiving elements, M receiving signals as shown in FIG. 17 can be received.

If taking a logical multiplication of these M pulse signals, signals in which the time from transmission to reception is the same, that is, only a mail image pulse can be detected as the output result, and can be separated from the side image pulse.

Moreover, if taking a logical addition of these M pulse signals, signals in which the time from transmission to reception is different, that is, only a side image pulse can be also detected.

With such a principle, the electronic scanning ultrasonic object-detection apparatus 1 in this embodiment can separate the mail image pulse and the side image pulse.

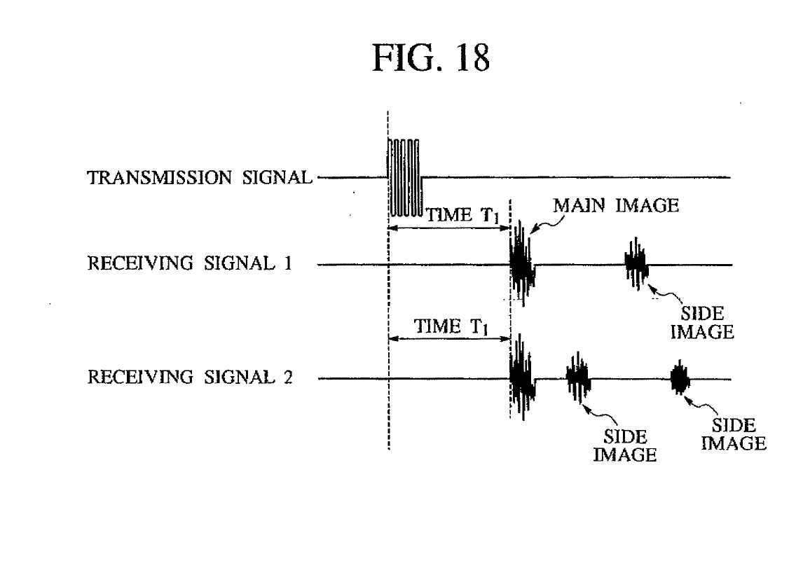

In the case where an object is detected in two arrays A₁, A₂ shown in FIG. 9, based on the above-described principle, when arrays A₁, A₂ transmit ultrasonic waves having different transmission frequencies (S904), and the ultrasonic waves are reflected by the object (S905), the reflected waves are received by the receiving elements C₁, C₂ shown in FIG. 9 (S906). An example of this receiving signal is shown in FIG. 18.

The receiving signal shown in FIG. 18 is identified and separated into a mail image and a side image by ultrasonic wave receiving means 4 having a circuit structure as shown in FIG. 7.

At first, when the receiving element C₁ receives a reflected wave of a frequency of 40 kHz, and the receiving element C₂ receives a reflected wave of a frequency of 50 kHz, the received reflected waves are amplified by the amplifier AMP at the same time (S907), and are subjected to pulse transform by means of the automatic gain control device AGC and the peak hold circuit 41 (S905).

If a logical multiplication of the pulse signals generated in this manner is calculated, signals in which the time from transmission to reception is the same, that is, the receiving signal after time T₁ in FIG. 18 can be detected as a “mail image”. Moreover, receiving signals other than that signal can be detected as a “side image”, by calculating a logical addition (S909).

In this manner, after the reflected wave is transformed to a pulse signal, a plurality of receiving signals can be collectively processed by the logic construction. As a result, the construction of the receiving circuit can be made small, and existence of a “side image” can be also judged.

Based on this mail image pulse, the distance and direction to the object is calculated, and existence of a side image is detected based on the side image pulse (S910).

In particular, the distance to the object can be measured by a time required from the transmission time of ultrasonic waves to the reception time of the reflected waves, and the direction can be known from the main beam direction.

Then, positional information (angle and distance) of an object existing in the space can be detected, by performing the above-described detection of the object in the range of the main beam direction of −90°≦α₀≦90°.

What is claimed is:

1. An electronic scanning ultrasonic object-detection apparatus for detecting a position of an object by transmitting ultrasonic waves, comprising:
phase control signal generation means for generating a plurality of phase control signals having different transmission frequencies;
ultrasonic wave transmission means for transmitting ultrasonic waves of a transmission frequency different from each other by a plurality of arrays, based on said plurality of phase control signals generated by said phase control signal generation means;
ultrasonic wave receiving means for receiving reflected waves from an object of the ultrasonic waves transmitted by said ultrasonic wave transmission means, with a plurality of receiving elements, judging a signal of the reflected wave received by all the receiving elements as a mail image to thereby output a mail image signal, and judging signals of other reflected waves as side images to thereby output a side image signal; and
object-detection means for detecting a position of an object based on said mail image signal output by said ultrasonic wave receiving means, and detecting existence of a side image based on said side image signal.

2. An electronic scanning ultrasonic object-detection apparatus according to claim 1, wherein
said ultrasonic wave receiving means has logical operation means for transforming said reflected waves to pulse signals, and thereafter, collectively calculating said pulse signals.

3. An electronic scanning ultrasonic object-detection apparatus according to claim 1, wherein
said ultrasonic wave receiving means has logical operation means for transforming said reflected waves to pulse signals, and thereafter, detecting signals of which time required from transmission to reception is the same as a mail image pulse, among said pulse signals.

4. An electronic scanning ultrasonic object-detection apparatus according to claim 1, wherein
said ultrasonic wave receiving means has logical operation means for transforming said reflected waves to pulse signals, and thereafter, detecting signals of which time required from transmission to reception is different as a side image pulse, among said pulse signals.

5. An electronic scanning ultrasonic object-detection method for detecting a position of an object by transmitting ultrasonic waves, comprising;
a phase control signal generation step for generating a plurality of phase control signals having different transmission frequencies;
an ultrasonic wave transmission step for transmitting ultrasonic waves of a transmission frequency different from each other by a plurality of arrays, based on said plurality of phase control signals generated by said phase control signal generation step;
an ultrasonic wave receiving step for receiving reflected waves from an object of the ultrasonic waves transmitted in said ultrasonic wave transmission step, with a plurality of receiving elements, judging a signal of the reflected waves received by all the receiving elements as a mail image to thereby output a mail image signal, and judging signals of other reflected waves as side images to thereby output a side image signal; and
an object-detection step for detecting a position of an object based on said mail image signal output in said ultrasonic wave transmission step, and detecting existence of a side image based on said side image signal.

6. An electronic scanning ultrasonic object-detection method according to claim 5, wherein
said ultrasonic wave receiving step has a logical operation step for transforming said reflected waves to pulse signals, and thereafter, collectively calculating said pulse signals.

7. An electronic scanning ultrasonic object-detection step according to claim 5, wherein
said ultrasonic wave receiving step has a logical operation step for transforming said reflected waves to pulse signals, and thereafter, detecting signals of which time required from transmission to reception is the same as a mail image pulse, as a mall image pulse, among said pulse signals.

8. An electronic scanning ultrasonic object-detection method according to claim 5, wherein
said ultrasonic wave receiving step has a logical operation step for transforming said reflected waves to pulse signals, and thereafter, detecting signals of which time required from transmission to reception is different as a side image pulse, among said pulse signals.
